(19) United States
(12) Patent Application Publication
(10) Pub. No.: US 2012/0016949 A1
(43) Pub. Date: Jan. 19, 2012

(54) DISTRIBUTED PROCESSING SYSTEM, INTERFACE, STORAGE DEVICE, DISTRIBUTED PROCESSING METHOD, DISTRIBUTED PROCESSING PROGRAM

(76) Inventors: Junichi Higuchi, Tokyo (JP); Youichi Hidaka, Tokyo (JP); Takashi Yoshikawa, Tokyo (JP)

(21) Appl. No.: 13/258,866

(22) PCT Filed: Mar. 15, 2010
(86) PCT No.: PCT/JP2010/054739

§ 371 Date: Sep. 22, 2011

(30) Foreign Application Priority Data
Mar. 23, 2009 (JP) 2009-070310

(51) Int. Cl. G06F 15/16; G06F 15/167

(52) U.S. Cl. 709/212; 709/217

(57) ABSTRACT

A distributed processing system which distributes a load of a request from a client without being restricted by a processing status and processing performance of transfer processing means is provided:

A distributed processing system includes: processing means for processing a request from request means and generating a reply; a switch connected to the processing means; memory means connected to the switch; and an interface, connected to a network, the request means being connected to, and to the switch, for transferring the request from the request means to the memory means and for transferring the reply to the request means, wherein the memory means comprises: first control means for determining whether State management is required for the transferred request; first storage means for storing a request that requires the State management; and second storage means for storing a request that does not require the State management, the first control means eliminates the request stored in the first or the second storage means, based on an instruction from the processing means, and the processing means comprises second control means for detecting a load, reading out the request stored in the first or the second storage means according to the load, and outputting the generated reply to the interface.

### TECHNICAL FIELD

The present invention relates to a system, a network interface, a storage device in a network, a distributed processing method and a distributed processing program that distribute a load in a network where a plurality of computers are connected, and particularly to a distributed processing system, a storage device, a memory type network interface, a distributed processing method and a distributed processing program, in which transfer overhead is reduced.

### BACKGROUND ART

Patent document 1 discloses a distributed processing system, which distributes a load by distributing processing requests from a client group to network apparatuses such as a plurality of computers or a server group connected to a network.

FIG. 19 shows a distributed processing system disclosed in patent document 1. In the distributed processing system 1001, a client group 1002 on an IP (Internet Protocol) network 1003 and a server group 1006 on an IP network 1005 are connected via a load balancer 1004. A request from each client 1012 of the client group 1002 is transmitted to the load balancer 1004 via the network 1003. The load balancer 1004 monitors a load on each server 1016 of the server group 1006, and distributes requests to each server according to a distributed processing leveling algorithm. Each server 1016 processes the distributed request.

FIG. 20 shows a part of the distributed processing system 1001, shown in FIG. 19, including the load balancer 1004, the IP network 1005 and the server group 1006. FIG. 20 further shows detailed structure of the load balancer 1004 and detailed structure of the server 1016 included in the server group 1006 as a block diagram.

The load balancer 1004 includes a client side Network interface Card (NIC) 1041 connected to the IP network 1003, a server side NIC 1045 connected to the IP network 1005 and a chipset 1043 which connects the client side NIC 1041, the server side NIC 1045, a memory 1042 and a Central Processing Unit (CPU) 1044. Each server 1016, included in the server group 1006, includes a NIC 1061 connected to the IP network 1005 and a chipset 1063 which connects this NEC, a memory 1062 and a CPU 1064.

In the load balancer 1004 and server 1016, respectively, a NIC and a chipset are connected by PCI (Peripheral Component Interconnect) or PCI Express. The NIC and the IP network of each are connected by Ethernet (registered trademark). The client 1012, the load balancer 1004 and the server 1016 send and receive a request and a reply using TCP/IP (Transmission Control Protocol/Internet Protocol).

FIG. 21 schematically shows a sequence of operations of the distributed processing system 1001. A request transmitted from the client 1012 passes the IP network 1003 as a TCP/IP packet, and is received at the client side NIC 1041 of the load balancer 1004. Further, in the load balancer 1004, the request is stored in the memory 1042 via the chipset 1043. By a distributed processing program operating on the CPU 1044, the server (SV) 1016 for a forwarding destination of the request is selected. The request stored in the memory 1042 is converted so that the destination of the request is the selected server. The converted request is read from the memory 1042 via the chipset 1043, and is transmitted from the server side NIC 1045 as a TCP/IP packet. The request outputted from the load balancer 1004 passes the IP network 1005 and is received at the NIC 1061 of the server 1016 selected as the destination. In the selected server 1016, the received request is stored in the memory 1062 via the chipset 1063. Then, it is processed by a processing program operating on the CPU 1064. The result of the processing is stored in the memory 1062 as a reply. The reply is read from the memory 1062 via the chipset 1063, and is transmitted from the NIC 1061 as a TCP/IP packet.

The reply outputted from the server 1016 passes the IP network 1005, and is received at the server side NIC 1045 of the load balancer 1004. The reply is stored in the memory 1042 via the chipset 1043. Then, by the distributed processing program operating on the CPU 1044, the reply stored in the memory 1042 is converted so that the destination of the reply is the client 1012, which is the source of the request. The converted reply is read from the memory 1042 via the chipset 1043, and is transmitted to the client 1012 from the client side NIC 1041 as a TCP/IP packet.

Furthermore, patent document 2 discloses a multiprocessor system having a plurality of processors, each of which processes control signals conforming to a predetermined sequence in order and performs distributed processing, and a function handover control method which carries out handover of the function of transfer processing. In patent document 2, an arbitration substrate performs arbitration when a competition of requests for use of a common bus occurs at the time of accessing to a CP (Central Processing) substrate or at the time of accessing from the CP substrate to a common memory substrate, and also performs arbitration of access from input/output devices to the common memory substrate in the case of DMA (Direct Memory Access) transfer.

Patent document 3 discloses a distributed processing method for a plurality of computers connected to an arbitrary network. In patent document 3, each computer acquires its own RAS (Remote Access Service) information, transmits it to each of other computers, receives RAS information from each of the other computers and stores it in a main storage device along with its own RAS information. When a operation request from a client is accepted, each computer refers to the RAS information in its own main storage device to perform distributed processing.

Patent document 4 discloses a distributed processing method in a multiprocessor system including a plurality of processors. In patent document 4, a user program is divided into a plurality of tasks and kept in a main memory. Each SPU (sub processor unit) performs a DMA transfer for a task, which is stored in the main memory and is in an executable state, to a local memory and performs the task. Each SPU assigns a time-divided CPU time to execute the task, and carries out the task. When the assigned CPU time is exhausted, the DMA transfer is performed for the task to the main memory from the local memory, and the task is saved.

### CITATION LIST

### Patent Document

[Patent document 1] Japanese Patent Application Laid-Open No. 2008-71156
[Patent document 2] Japanese Patent Application Laid-Open No. 2001-166955
[Patent document 3] Japanese Patent Application Laid-Open No. 2007-133665
[Patent document 4] Japanese Patent Application Laid-Open No. 2008-146503

### DISCLOSURE OF THE INVENTION

However, in the distributed processing system 1001 disclosed in patent document 1, because the load leveling processing and the transfer processing for a TCP/IP packet in the load balancer 1004 mutually constrain each other, the respective pieces of processing are rate-determining steps for the whole distributed processing. When the number of servers increases, the load leveling processing of this load balancer 1004 becomes a bottleneck of the processing speed of the entire system. When a traffic amount increases, this transfer processing of the TCP/IP packet becomes a bottleneck of the processing speed of the entire system. That is, the processing capacity of the load balancer 1004 constrains a scalability of the whole distributed processing system.

The multiprocessor system and the function handover control method described in patent document 2, store a control signal to be requested in a shared memory substrate, and retrieve a CP substrate of a forwarding destination based on a key number appended to the control signal. Input processing and output processing in this shared memory substrate mutually constrains each other, and the respective speeds of the input processing and of the output processing restrict the processing speed of the entire system.

The distributed processing method described in patent document 3 receives the RAS information from other computers and stores it in the main storage device along with its own RAS information. When the operation request from the client is received, the RAS information in its own main storage device is referred to. In the distributed processing method disclosed in patent document 3, a reference operation of the main memory constrains input/output processing. A speed of the reference operation constrains the processing speed of the entire system.

A distributed processing method disclosed in patent document 4 transfers a plurality of tasks held in the main memory to a local memory by DMA transfer and performs the tasks. Also in a distributed processing method disclosed in patent document 4, input and output processing in a plurality of tasks held in the main memory restricts each other, and thus each of input processing and output processing restricts the processing speed of the entire system.

The present invention has been made in view of the above-mentioned problems, and the object is to eliminate constraints between pieces of processing in a load balancer and to reduce transfer overhead. That is, the object is to provide a distributed processing system, interface, a storage device, a distributed processing method and a distributed processing program which distribute a load of request from a client without constrained by the state of processing and the performance for processing of a transfer processing means such as a load balancer.

### Means for Solving the Problems

In order to solve the above problems, a distributed processing system according to the present invention includes: processing means for processing a request from request means and generating a reply; a switch connected to the processing means; memory means connected to the switch; and an interface, connected to a network, the request means being connected to, and to the switch, for transferring the request from the request means to the memory means and for transferring the reply to the request means, wherein the memory means comprises: first control means for determining whether State management is required for the transferred request; first storage means for storing a request that requires the State management; and second storage means for storing a request that does not require the State management, the first control means eliminates the request stored in the first or the second storage means, based on an instruction from the processing means, and the processing means comprises second control means for detecting a load, reading out the request stored in the first or the second storage means according to the load, and outputting the generated reply to the interface.

In order to solve the above problems, an interface according to the present invention is connected to a switch, to which processing means for processing a request from request means and for generating a reply and memory means are connected, and to a network, to which the request means is connected. The interface includes: transfer means for transferring a request from the request means to the memory means, and for transferring the reply to the request means, wherein the request is transferred to the storage device using DMA transfer.

In order to solve the above problems, a memory means according to the present invention is connected to a switch, to which processing means for processing a request from request means and for generating a reply, and an interface, connected to a network, the request means being connected to, for transferring the reply to the request means are connected. The memory means includes: first control means for determining whether State management is required for a request from the request means transferred from the interface or not; first storage means for storing a request, which requires the State management; and second storage means for storing a request, which does not require the State management, wherein the first control means eliminates the request stored in the first or the second storage means based on an instruction from the processing means.

In order to solve the above problems, a distributed processing method according to the present invention is a method in a system, which includes: processing means for processing a request from request means and for generating a reply; a switch, the processing means being connected to; memory means connected to the switch; and an interface connected to a network, the request means being connected to, and to the switch.

The method includes: a step of transferring a request from the request means to the memory means; a step of determining whether State management is required for the transferred request or not; a step of storing the request in first storage means when the State management is required for the request; a step of storing the request in second storage means when the State management is not required for the request; a step of reading out the request according to a load on the processing means, and transferring to the processing means; a step of transferring a reply generated by processing the request to the request means; and a step of eliminating the request stored in the first or the second storage means.

In order to solve the above problems, a distributed processing program according to the present invention is a program in a system, which includes: processing means for processing a request from request means and for generating a reply; a switch, the processing means being connected to; memory means connected to the switch; and an interface connected to a network, the request means being connected to, and to the switch. The program causes a computer to execute: a step of transferring a request from the request means to the memory means; a step of determining whether State management is required for the transferred request or not; a step of storing the request in first storage means when the State management is required for the request; a step of storing the request in second storage means when the State management is not required for the request; a step of reading out the request according to a load on the processing means; and transferring to the processing means; a step of transferring a reply generated by processing the request to the request means; and a step of eliminating the request stored in the first or the second storage means.

### Advantage of the Invention

According to the present invention, a distributed processing system, a network interface, a storage device, a memory type network interface, a distributed processing method and a distributed processing program, which eliminate the bottleneck of the load balancer and reduce the transfer overhead, are provided.

### BRIEF DESCRIPTION OF THE DRAWINGS

FIG. 1 shows an example of configuration of a distributed processing system according to first and second exemplary embodiments of the present invention;

FIG. 2 shows an example of configuration of a multi-root (MR) compliant PCI Express (PCIe) storage device according to the first exemplary embodiment of the present invention;

FIG. 3 is a diagram showing an outline of an example of a sequence of operations in a distributed processing system according to the first, second and fourth exemplary embodiments;

FIG. 4 is a flow chart showing an example of processing in the distributed processing system according to the first exemplary embodiment;

FIG. 5A shows an example of configuration of a processing unit according to the first to fourth exemplary embodiments of the present invention;

FIG. 5B shows an example of configuration of software, which operates on a processing unit according to the first to fourth exemplary embodiments of the present invention;

FIG. 6 shows an example of configuration of a MR compliant PCIe network interface card according to the second and fourth exemplary embodiments of the present invention;

FIG. 7 shows an example of configuration of a MR compliant PCIe storage device according to the second and fourth exemplary embodiments;

FIG. 8 is a flow chart showing an example of processing when a request packet arrives from a client in a distributed processing system according to the second and fourth exemplary embodiments.

FIG. 9 shows an example of configuration of a State management table according to the second to fourth exemplary embodiments.

FIG. 10 is a flow chart showing an example of processing when the processing unit processes a request packet in the distributed processing system according to the second and fourth exemplary embodiments;

FIG. 11 is a flow chart showing an example of processing for transmitting a response packet to the client in the distributed processing system according to the second and fourth exemplary embodiments;

FIG. 12 shows an example of configuration of a distributed processing system according to the third exemplary embodiment of the present invention;

FIG. 13 shows an example of configuration of a MR compliant PCIe memory type network interface card according to the third exemplary embodiment of the present invention;

FIG. 14 is a diagram showing an outline of an example of a sequence of operations of the distributed processing system according to the third exemplary embodiment;

FIG. 15 is a flow chart showing an example of processing when a request packet arrives from a client in the distributed processing system according to the third exemplary embodiment.

FIG. 16 is a flow chart showing an example of processing when a processing unit processes the request packet in the distributed processing system according to the third exemplary embodiment;

FIG. 17 is a flow chart showing an example of processing for transmitting a response packet to the client in the distributed processing system according to the third exemplary embodiment;

FIG. 18 shows an example of configuration of a distributed processing system according to the fourth exemplary embodiment of the present invention;

FIG. 19 is a diagram showing configuration of the distributed processing system related to the present invention;

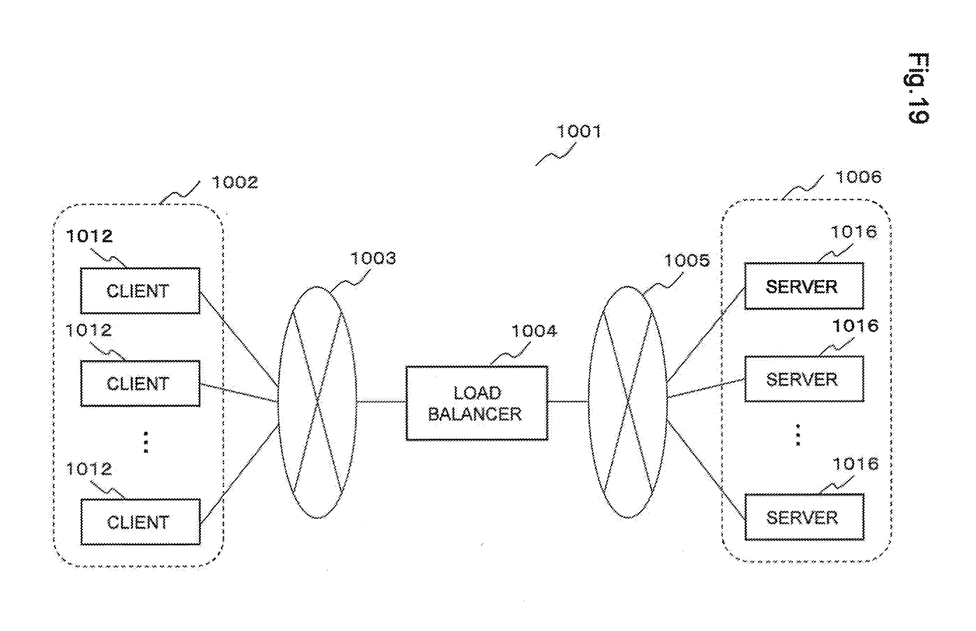

FIG. 20 is a block diagram of a load balancer, an IP network and a server group of a distributed processing system related to the present invention; and

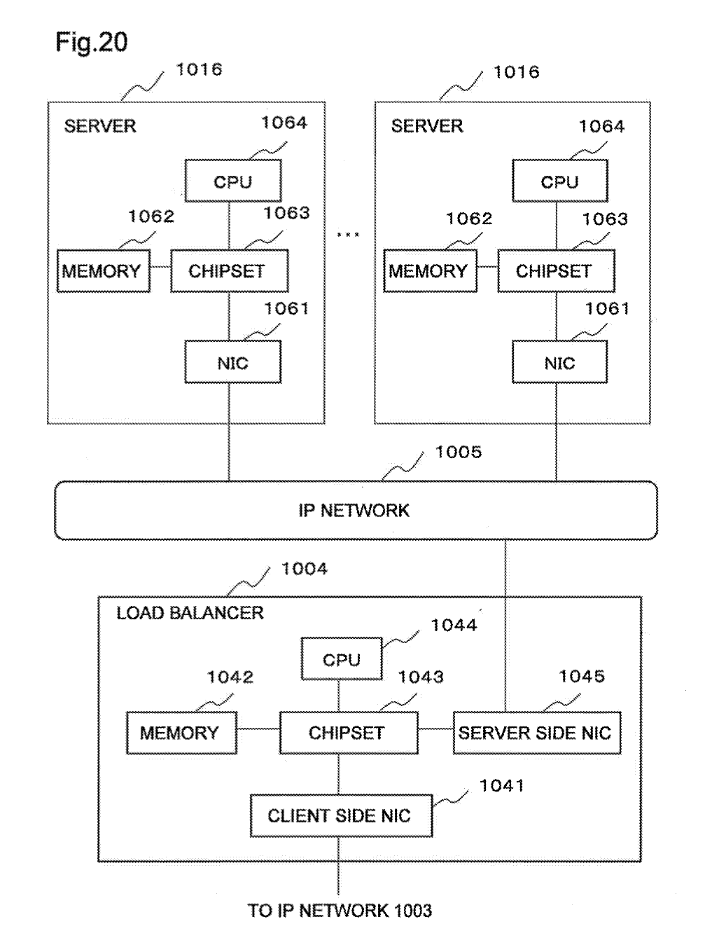

FIG. 21 is a diagram showing an outline of a sequence of operations of a distributed processing system related to the present invention.

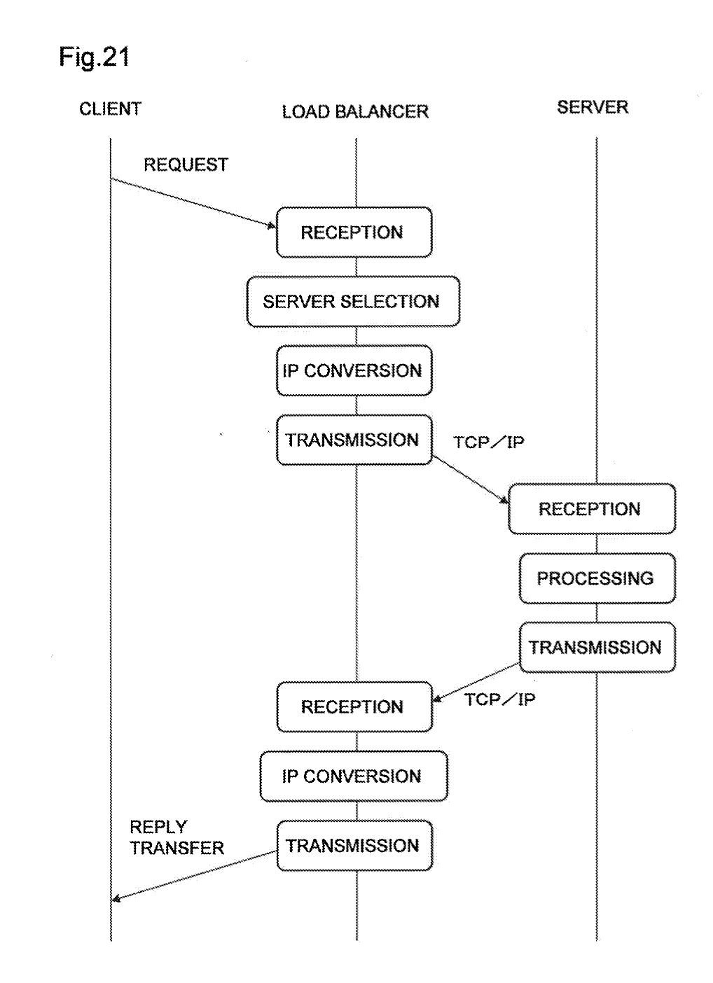

### DESCRIPTION OF EMBODIMENTS

Hereinafter, the embodiments of the present invention will be described in detail with reference to the drawings.

### The First Exemplary Embodiment

The first exemplary embodiment, in which the present invention is implemented suitably, will be described.

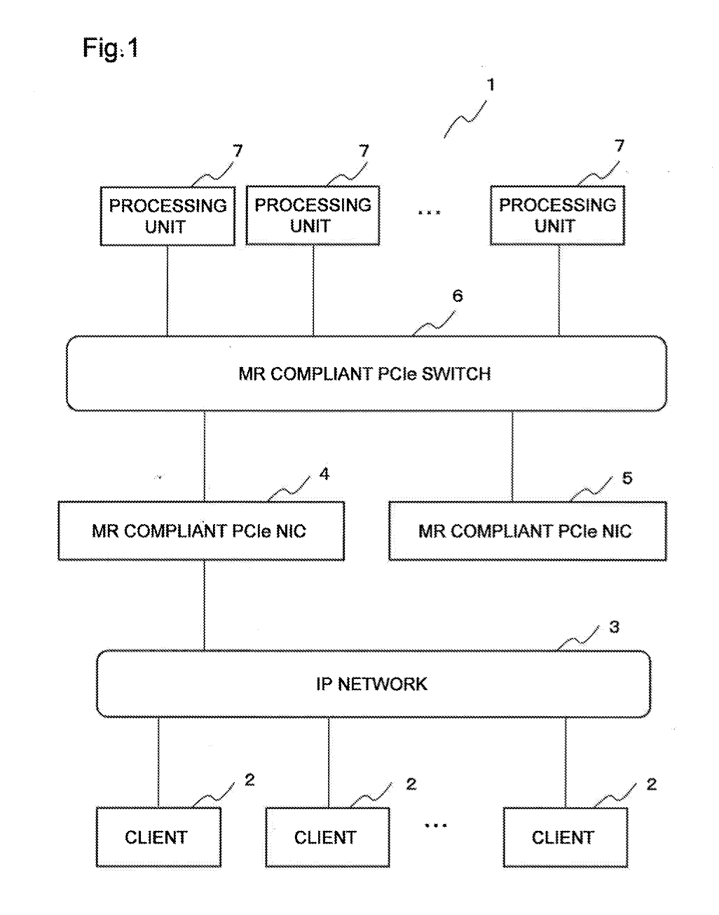

FIG. 1 shows an example of configuration of a distributed processing system according to the first exemplary embodiment of the present invention.

The distributed processing system 1 includes: a multi-root (hereinafter, abbreviated to MR) compliant PCI Express (hereinafter, abbreviated to PCIe) network interface card (hereinafter, abbreviated to NIC) 4 connected to a client 2 on an IP network 3; and an MR compliant PCIe switch 6 connected to the MR compliant PCIe NIC 4. A MR compliant PCIe storage device 5 is connected to the MR compliant PCIe switch 6. Furthermore, to the MR compliant PCIe switch 6, a processing unit 7, which processes a request from the client 2, is connected.

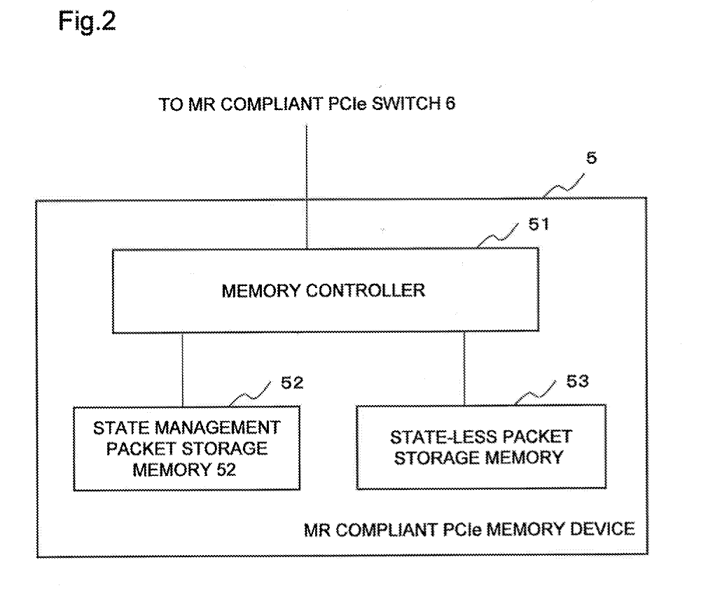

FIG. 2 shows an example of configuration of the MR compliant PCIe storage device 5 in the first exemplary embodiment of the present invention. The MR compliant PCIe storage device 5 includes a State management packet storage memory 52 and a State-less packet storage memory 53. Meanwhile, “State” includes information on a situation where the request is processed or information on condition for processing. For example, State may include information on order of pieces of processing including processing for other requests. The State management packet storage memory 52 and the State-less packet storage memory 53 are connected to the MR compliant PCIe switch 6 via a memory controller 51. That is, the memory controller 51 classifies request packets transferred from the MR compliant PCIe NIC 4 into packets for State management application and packets for State-less application. The State management packet storage memory 52 stores a request packet for State management application. The State-less packet storage memory 53 stores a request packet for State-less application. Further, the memory controller 51 eliminates from the State management packet storage memory 52 or the State-less packet storage memory 53 the request packet corresponding to a deletion request from the processing unit 7. Meanwhile, the State management packet storage memory 52 uses DMA (Direct Memory Access) transfer for a data transfer to the other equipment.

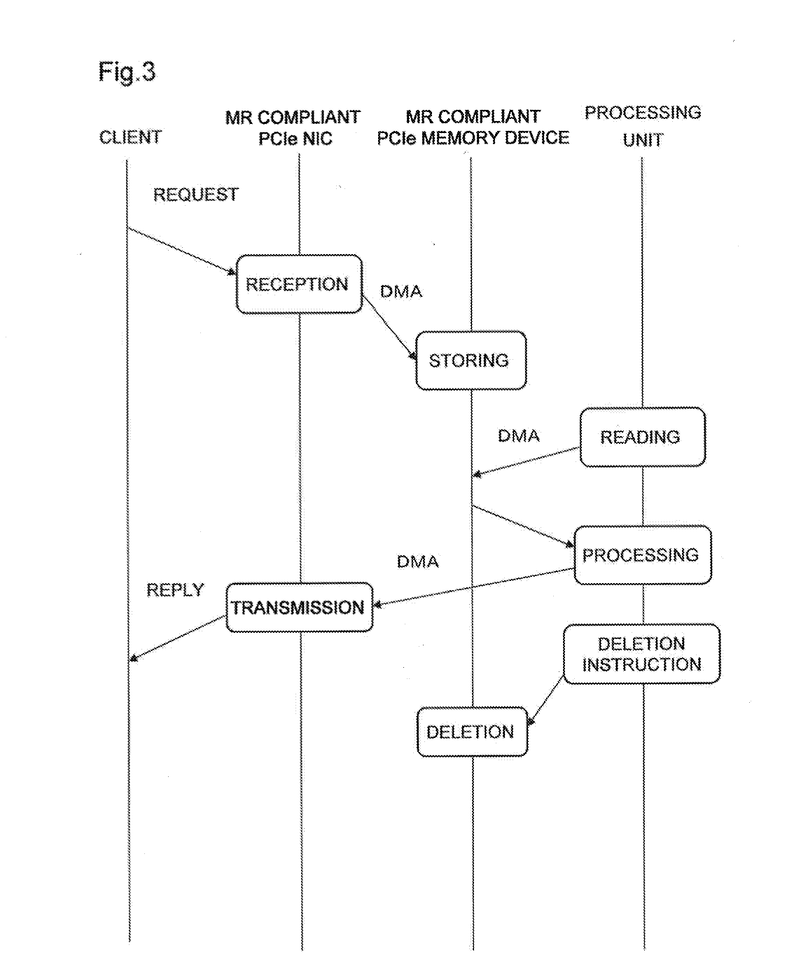

Next, an example of operations in the distributed processing system 1 according to the embodiment 1 of the present invention will be described with reference to FIGS. 1 and 3. FIG. 3 schematically shows an example of an operation sequence in the distributed processing system 1.

The request transmitted from the client 2 passes the IP network 3 as a TCP/IP packet, and is received at the MR compliant PCIe NIC 4. The request packet is stored in the MR compliant PCIe storage device 5 by a DMA transfer. This operation is performed for every reception of the request packet.

On the other hand, at the processing unit 7, the read operation is controlled based on a state of load. That is, according to the state of load on the processing unit 7, a request packet is read from the MR compliant PCIe storage device 5 by the DMA transfer, and the request packet is processed at the processing unit 7. When the processing for the request processing is completed, the processing unit 7 generates a response packet, and transfers the generated response packet to the MR compliant PCIe NIC 4 by DMA transfer. The MR compliant PCIe NIC 4 transmits the transferred response packet to the client 2. Furthermore, the processing unit 7 transmits a deletion instruction to the MR compliant PCIe storage device 5. The MR compliant PCIe storage device 5 eliminates the stored request packet according to the deletion instruction. In the operations from the receiving request packet reception to the transmitting response packet, data transfer is performed by the DMA transfer via the MR compliant PCIe switch 6.

Next, operations of the distributed processing system 1 will be described with reference to FIGS. 1, 2 and 4.

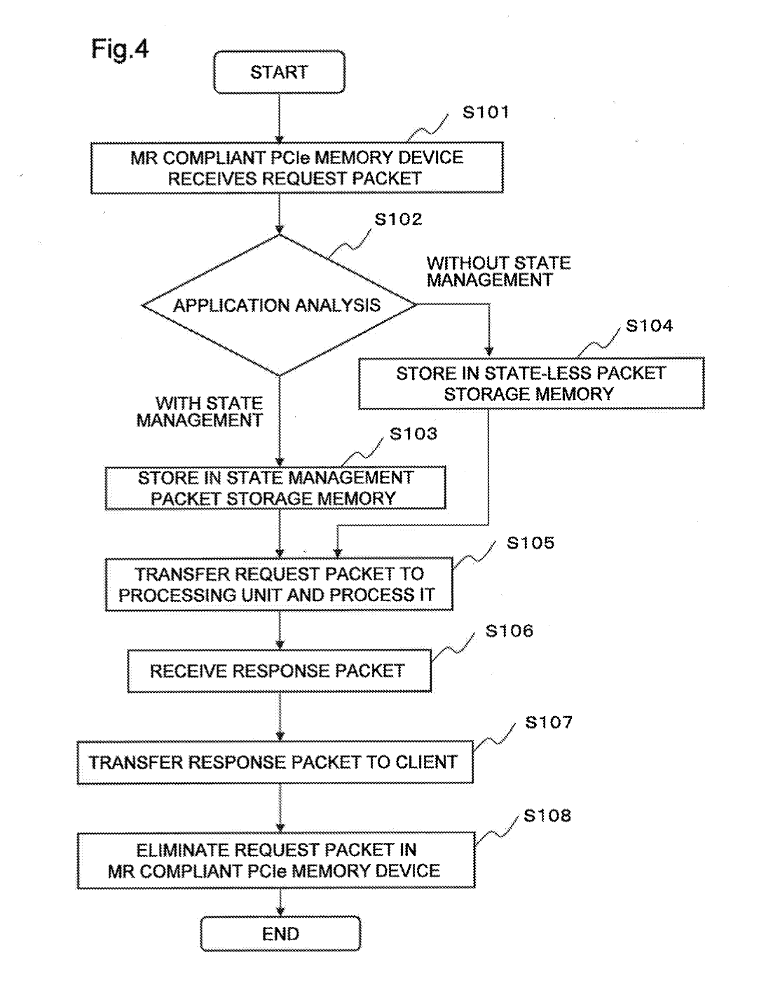

FIG. 4 shows an example of a flow of processing in the distributed processing system according to the first exemplary embodiment of the present invention.

The request packet from the client 2 arrives at the MR compliant PCIe NIC 4 from the IP network 3 on the client side (Step S101).

The request packet is transferred to the MR compliant PCIe storage device 5, and in the memory controller 51, it is determined whether it is a request, which requires performing the State management and storing at each of the flows, or not (Step S102).

The request packet is stored in the State-less packet storage memory 53 (Step S104), when it is distinguished as a State-less application (at Step S102/Without State management).

When the request packet is distinguished as an application, which requires the State management (at Step S102/With State management), the flow is analyzed. State information on the request packet is recorded, and the request packet is stored in the State management packet storage memory 52 (Step S103).

When the processing unit 7 is in a state where a request can be processed, the request packet is transferred from the MR compliant PCIe storage device 5 to the processing unit 7, and processed (Step S105). According to whether the processing unit 7 processes a request, which requires the State management, or not, the request packet is read from the State management packet storage memory 52 or the State-less packet storage memory 53, and transferred to the processing unit 7. When the request packet is read from the State management packet storage memory 52, information on the processing unit 7, performing the processing, is registered.

The processing unit 7 processes the request packet and generates a response packet. The MR compliant PCIe NIC 4 reads the response packet from the processing unit 7 (Step S106). The response packet is outputted to the client side network and is transmitted to the client, which issued the request (Step S107). After transmitting the response packet, the processing unit 7 sends a deletion instruction for the request packet to the MR compliant PCIe storage device 5 and eliminates the instructed request packet (Step S108).

As shown in the flowchart of FIG. 4, after processing the request packet in the processing unit 7, the response packet is transmitted and the processing for a request packet is resumed. On the other hand, the reception processing for the request packet is independent from these pieces of processing. As described above, the distributed processing system 1 according to the first exemplary embodiment of the present invention includes one MR compliant PCIe NIC 4 and one MR compliant PCIe storage device 5, but may include plural MR compliant PCIe NICs 4 and plural MR compliant PCIe storage devices 5.

The distributed processing system according to the first exemplary embodiment of the present invention includes an MR compliant PCIe device, and each processing unit processes stored packets autonomously. As a result, the TCP/IP transfer overhead can be reduced. The bottleneck of processing speed, as a whole, which has been a problem, is eliminated. In addition, the distributed processing does not include a complicated algorithm. For this reason, the performance of system improves.

### The Second Exemplary Embodiment

The second exemplary embodiment, to which the present invention is suitably implemented, will be described.

In the distributed processing system 1 according to the second exemplary embodiment, the same reference signs are given to the members and operations overlapped with those in the distributed processing system 1 according to the first exemplary embodiment, and description for them will be omitted.

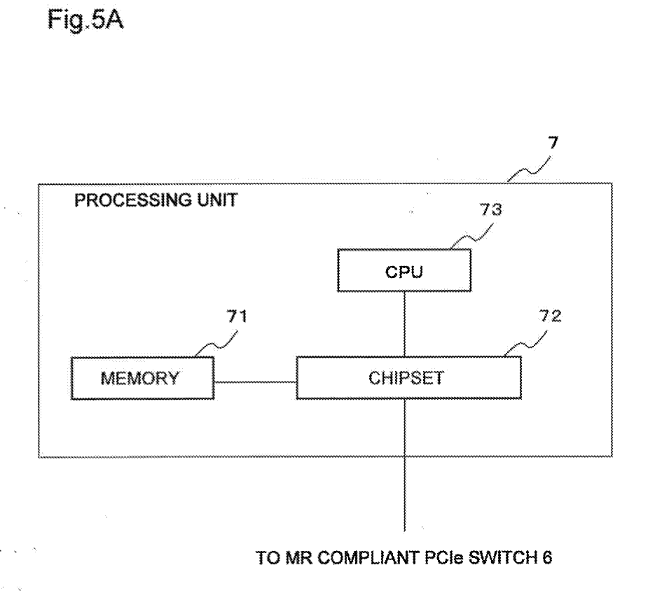

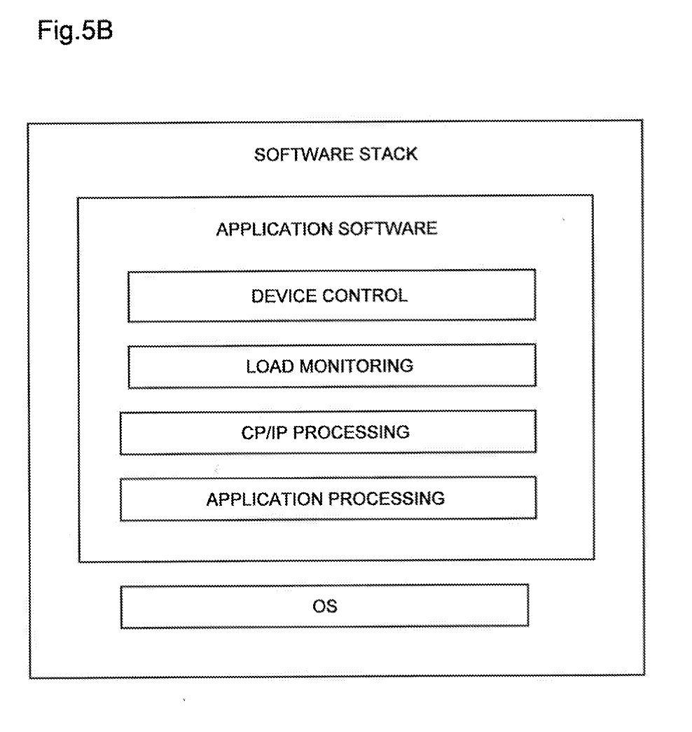

FIG. 5A shows an example of configuration of the processing unit 7 according to the second exemplary embodiment of the present invention. The processing unit 7 includes a memory 71, a Central Processing Unit (CPU) 73 and a chipset 72 connected to the memory 71 and the CPU 73. The memory 71 and the CPU 73 are connected to a MR compliant PCIe switch 6 via the chipset 72.

FIG. 5B shows an example of software, which operates on the processing unit 7, as a software stack. In the processing unit 7, the operating software (OS) and application software operate. The application software is, for example, software for load monitoring, TCP/IP processing and application processing. The software for application processing, performs processing for a request from a client and generates a response packet, for example. The application software may include software for device controlling, which sets a DMA controller for each device and controls transfer of data or the like.

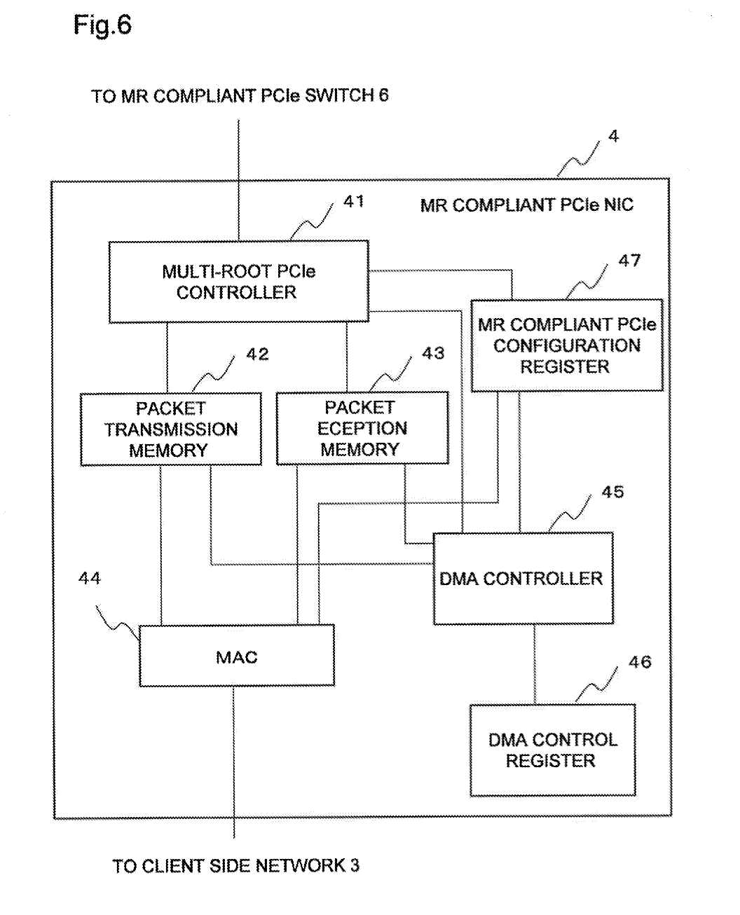

FIG. 6 shows an example of configuration of the MR compliant PCIe NIC 4 according to the second exemplary embodiment of the present invention. The MR compliant PCIe NIC 4 includes: a multi-root PCIe controller 41 connected to a MR compliant PCIe switch 6; a media access controller (hereinafter, referred to as MAC) 44 connected to a client side network 3; a packet transmission memory 42 and a packet reception memory 43, each connected to the multi-root PCIe controller 41 and the MAC 44. The MR compliant PCIe NIC 4 further includes a DMA controller 45 connected to the multi-root PCIe controller 41, the packet transmission memory 42 and the packet reception memory 43. To the DMA controller 45, a DMA control register 46 is connected. An MR compliant PCIe configuration register 47 is connected to the multi-root PCIe controller 41, the DMA controller 45 and the MAC 44. Meanwhile, the packet transmission memory 42 may be a plurality of memories. Correspondingly to the packet transmission memory 42, the packet reception memory 43 may be a plurality of memories, and furthermore, the DMA controller 45 may also be a plurality of controllers. The DMA control register 46 also may be a plurality of registers.

The MR compliant PCIe NIC 4 receives a request packet transmitted from a client 2 via the client side network 3 and transfers the request packet to the MR compliant PCIe storage device 5. Furthermore, the MR compliant PCIe NIC 4 transmits a response packet, which the processing unit 7 processes the request packet to generate, to the client 2 via the client side network 3.

The MR compliant PCIe NIC 4 includes the multi-rate PCIe controller 41 and the MR compliant PCIe configuration register 47. The more than one processing units 7 use simultaneously the MR compliant PCIe NIC 4 via the MR compliant PCIe switch 6. Since method of operation of these more than one processing units 7 is disclosed in non-patent document 1, detailed description will be omitted.

### CITATION LIST

### Non-Patent Document

[Non-Patent Document 1] Multi-Root I/O Virtualization and Sharing Specification Revision 1.0, PCI-SIG, May 12, 2008, pp. 29.

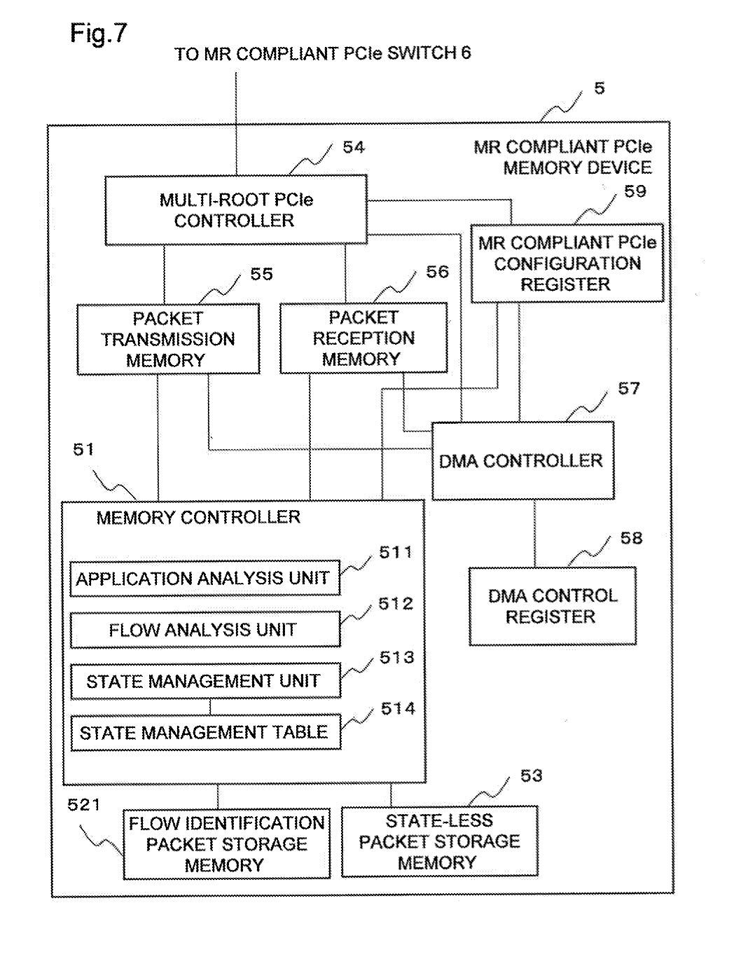

FIG. 7 shows an example of configuration of the MR compliant PCIe storage device 5 according to the first exemplary embodiment of the present invention in detail.

The MR compliant PCIe storage device 5 includes: a multi-root PCIe controller 54 connected to a MR compliant PCIe switch; a memory controller 51; and a packet transmission memory 55 and a packet reception memory 56, each connected to the multi-root PCIe controller 54 and the memory controller 51. The MR compliant PCIe storage device 5 further includes a DMA controller 57 connected to the multi-root PCIe controller 54, the packet transmission memory 55 and the packet reception memory 56. The DMA control register 58 is connected to the DMA controller 57. An MR compliant PCIe configuration register 59 is connected to the multi-root PCIe controller 54, the DMA controller 57 and the memory controller 51. The memory controller 51 includes an application analysis unit 511, a flow analysis unit 512, a State management unit 513 and a State management table 514. To the memory controller 51, a flow identification packet storage memory 521 and a State-less packet storage memory 53 are connected. The flow identification packet storage memory 521 corresponds to the State management packet storage memory 52 in FIG. 2. Meanwhile, the packet transmission memory 55 may be a plurality of memories. Correspondingly to the packet transmission memory 55, the packet reception memory 56 may be a plurality of memories, and furthermore, DMA controller 57 may also be a plurality of controllers. Also, the DMA control register 58 may be a plurality of registers.

The MR compliant PCIe storage device 5 analyzes a request packet received from the client side network 3, classifies it into a request packet, for which State management is needed, or a request packet, for which State management is not needed, to store. Instruction from the processing unit 7 is stored in the DMA controller or in the DMA control register in advance. The MR compliant PCIe storage device 5 classifies a request packet, for which State management is needed, and a request packet, for which State management is not needed, according to the instruction from this processing unit 7 and sends the classified request packet to the processing unit 7. The stored request packet is eliminated, caused by the transmission of a response packet from the processing unit 7 to the client 2. In the present exemplary embodiment, the packet storage memory is divided into a memory for State management type application and a memory for State-less type application. As a result, the State-less packet storage memory 53, which is a memory for State-less application, may for example have a configuration with a simple form such as FIFO (First In and First Out).

The MR compliant PCIe storage device 5 includes the multi-root PCIe controller 54 and the MR compliant PCIe configuration register 59. More than one processing units 7 use simultaneously the MR compliant PCIe storage device 5 via the MR compliant PCIe switch 6. A method of operations for such more than one processing units 7 are described in non-patent document 1.

Preferably, the MR compliant PCIe storage device 5 may be an auxiliary storage device, and particularly, may be an auxiliary storage device, having a short seek time, and high-speed reading and writing being possible. The auxiliary storage is, for example, an SSD (Solid State Drive) or the like. Since data volume of a packet stored in the MR compliant PCIe storage device 5 is small, if the seek time is shortened by adopting the auxiliary storage device, the reading and writing data are accelerated, thereby the processing time for the distributed processing system 1 is reduced.

Next, operations of the distributed processing system 1 according to the second exemplary embodiment of the present invention will be described in detail. First, with reference to FIGS. 1, 6, 7 and 8, operation when receiving the request packet from the client 2 will be described.

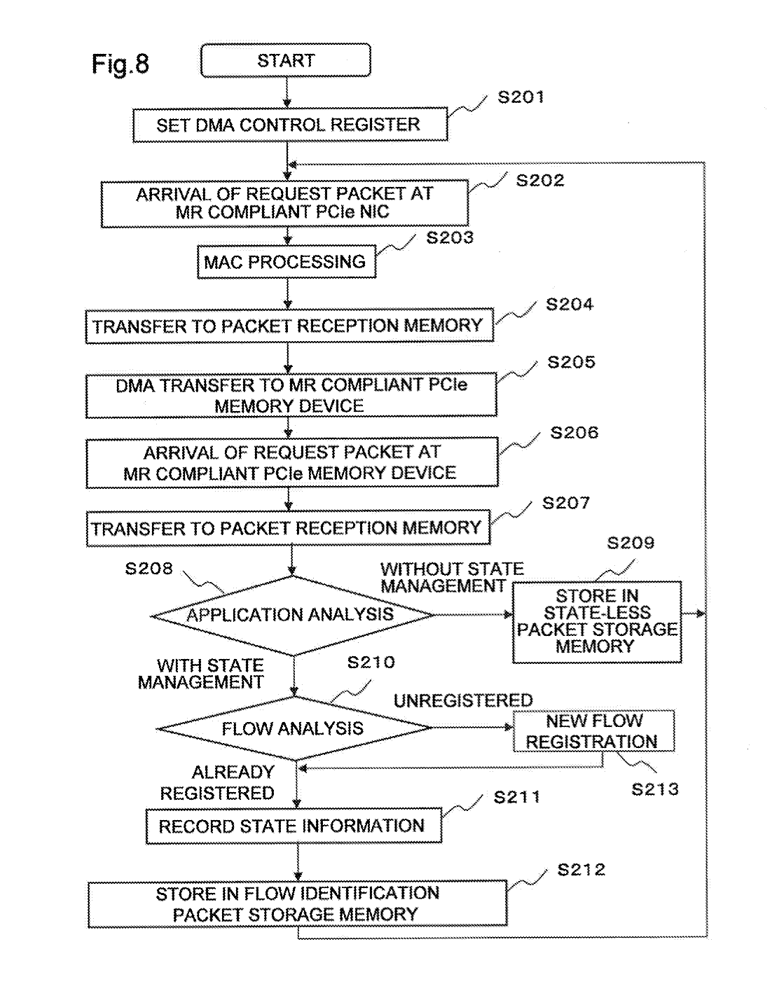

FIG. 8 shows a flow of operations when the request packet has arrived from the client 2.

After the system has been activated, the DMA control register 46 in the MR compliant PCIe NIC 4 and the DMA control register 58 in the MR compliant PCIe storage device 5 are configured (Step S201). When the MR compliant PCIe NIC 4 receives a request packet from the client 2 via the client side network 3 (Step S202), in the media access controller 44, the received request packet is performed MAC processing (Step S203). The MAC processed request packet is transferred to the packet reception memory 43 in the MR compliant PCIe NIC 4 (Step S204). Setting information is held in advance in the DMA control register 46 of the MR compliant PCIe NIC 4, so that the DMA controller 45 of the MR compliant PCIe NIC 4 transfers the received request packet to the MR compliant PCIe storage device 5. According to the setting information, the request packet transferred to the packet reception memory 43 is further transferred to the multi-root PCIe controller 54 of the MR compliant PCIe storage device 5 via the MR compliant PCIe switch 6 (Step S205).

When arriving at the MR compliant PCIe storage device 5 (Step S206), the request packet transferred from the MR compliant PCIe NIC 4 is transferred to the packet reception memory 56 via the multi-root PCIe controller 54 (Step S207). The memory controller 51 reads the request packet from the packet reception memory 56. In the application analysis unit 511, it is determined whether the read request packet requires performing the State management and storing at each of flows, or not (Step S208).

When the processing required by the request packet is determined to be a State-less application (at Step S208/Without State management), the request packet is stored in the State-less packet storage memory 53 (Step S209). Meanwhile, preferably the State-less packet storage memory 53 is the FIFO type.

When the processing required by the request packet is determined to be an application which requires State management (at Step S208/With State management), the flow is analyzed in the flow analysis unit 512 (Step S210). In this flow analysis, a flow is classified based on the classification of the client 2 that has transmitted the request packet. State information for the request packet, for which a flow has been analyzed, is recorded in the State management table 514 (Step S211). The request packet, whose State information has been recorded, is stored in the flow identification packet storage memory 521 (Step S212). The flow identification packet storage memory 521 includes a storage area classified by a flow so that a request packet may be stored at each of flows.

When there is a storage area, in which a different request packet having a flow of a request packet analyzed by the flow analysis unit 512 has already been stored (step S210/Already registered), the analyzed request packet is stored in the storage area so as to be processed after the different request packet that has already been stored.

When a different request packet having the flow of the request packet analyzed by the flow analysis unit 512 has not been stored yet (Step S210/Not registered), a storage area is newly prepared for this flow (Step S213), and the request packet is stored in this storage area.

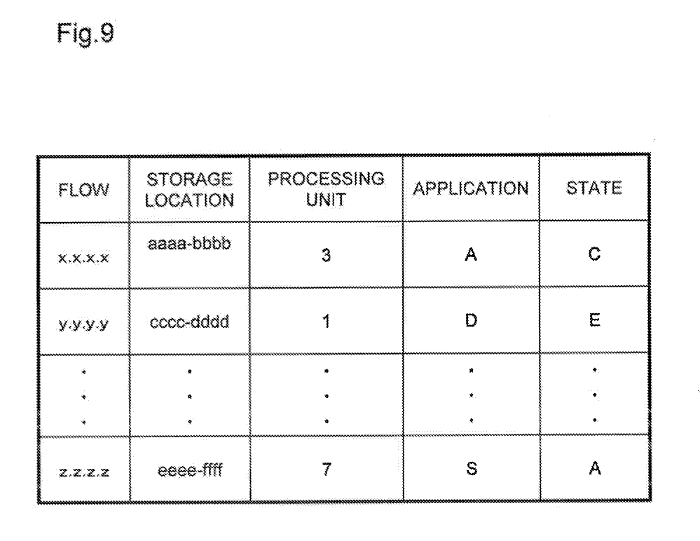

FIG. 9 shows an example of a configuration of the State management table 514, in which the State information of the request packet, for which the flow has been analyzed, is written.

The State management table 514 includes: a flow; a location of a storage area indicated by an address on the memory; an ID of a processing unit which processes the flow; information on an application which processes a request packet; and a record describing State information regarding the flow, for example.

Next, with reference to FIGS. 1, 5A, 7 and 10, processing of the request packet by a processing unit 7 will be described.

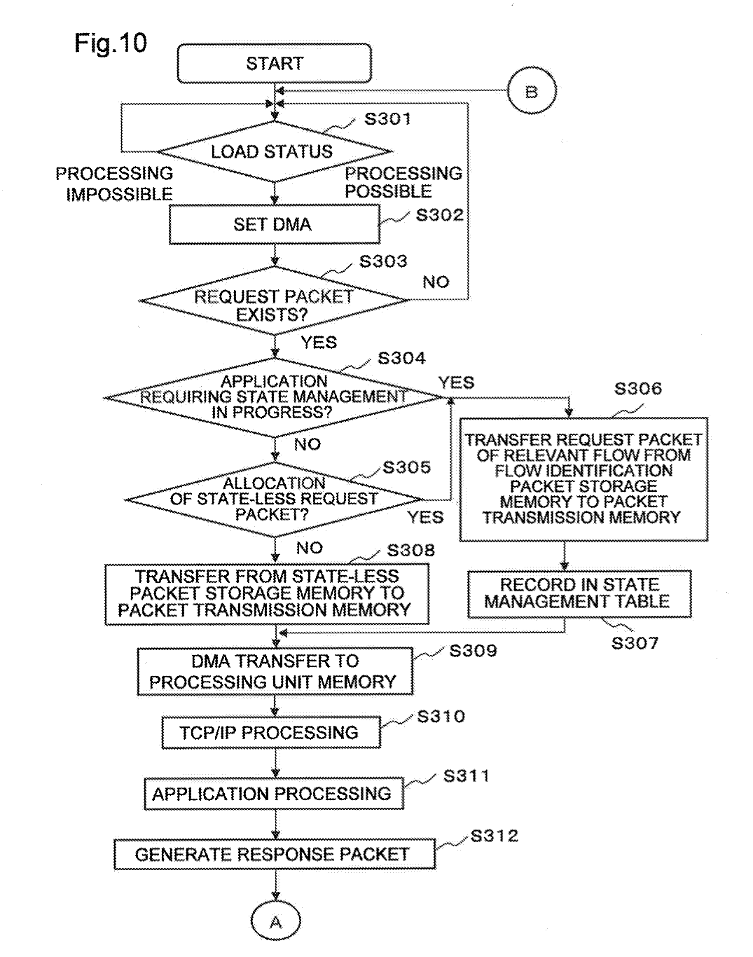

FIG. 10 shows a flow of operations in the request packet processing by the processing unit 7.

The processing unit 7 monitors a state of a load on the processing unit 7 as needed. That is, the processing unit 7 determines whether it is a state that a request packet can be processed, as needed (Step S301). When it is a state that the processing unit 7 can process the request packet (Step S301/Processing available), information indicating that the processing is available is transmitted to the MR compliant Pale storage device 5, and the situation of the processing unit 7 is set to the DMA controller 57 and the DMA control register 58 of the MR compliant PCIe storage device 5 (Step S302).

It is determined whether the request packet to be processed by the processing unit 7 is stored in the MR compliant Pale storage device 5 or not (Step S303), and when the request packet is stored (Step S303/YES), the request packet is transferred to the memory 71 of the processing unit 7 by the DMA controller 57 and the DMA control register 58 of the MR compliant PCIe storage device 5.

When the MR compliant PCIe storage device 5 transfers the request packet to the processing unit 7, the request packet to be transferred is selected according to the following procedure.

(1) When the processing unit 7 has already started an application for processing a request packet, for which State management is required (Step S304/YES), a request packet having a flow to be processed by the application is read from the flow identification packet storage memory 521. The DMA controller 57 of the MR compliant Pale storage device 5 includes a plurality of controllers, and the processing unit 7, capable of processing, selects one controller from the plurality of controllers. The packet reception memory 56 of the MR compliant PCIe storage device 5 includes a plurality of storage areas, and a storage area, which is controlled by the DMA controller 57 selected by the processing unit 7, is selected from the plurality of storage areas. The request packet is transferred by the controller from the flow identification packet storage memory 521 to the storage area (Step S306). Changes in the states of the processing unit 7 and the flow identification packet storage memory 521 due to the transfer of the request packet are recorded in the State management table 514 by the State management unit 513 (Step S307), and the request packet is transferred to the memory 71 of the processing unit 7 by DMA transfer (Step S309).

(2) When the processing unit 7 has not yet started application for processing the request packet for which the State management is required (Step S304/NO), a request packet is read from any one of the flow identification packet storage memory 521 and State-less packet storage memory 53. When the request packet is read from the flow identification packet storage memory 521 (step S305/YES), the read request packet is transferred to a storage area of the packet transmission memory 55 that the DMA controller 57 controls (Step S306). The flow of the read request packet and information on the processing unit 7, to which the processing has been assigned, is registered by the State management unit 513 to the state management table 514 (Step S307). The request packet transferred to the packet transmission memory 55 is transferred by the DMA controller 57 to the memory 71 of the processing unit 7 (Step S309). When the request packet has been read from the State-less packet storage memory 53 (step S305/NO), the request packet is transferred from the State-less packet storage memory 53 to a storage area of the packet transmission memory 55 that the DMA controller 57 controls (Step S308). The request packet transferred to the packet transmission memory 55 is transferred by the DMA controller 57 to the memory 71 of the processing unit 7 without performing the registration processing to the state management table 514. The ratio of the number of times that the request packet is read from the flow identification packet storage memory 521 to the number of times that the request packet is read from the State-less packet storage memory 53 is decided according to a readout algorithm, such as a round robin and a weighted round robin, which operates in the memory controller 51.

The request packet is transferred to the memory 71 of the processing unit 7 via the multi-root PCIe controller 54 of the MR compliant PCIe storage device 5, the MR compliant PCIe switch 6 and the chipset 72 of the processing unit 7 (Step S309). The request packet, which has arrived at the memory 71, undergoes the TCP/IP processing by the CPU 73 of the processing unit 7 (Step S310). The request packet, which has undergone the TCP/IP processing, is further processed by the application which is activated in the processing unit 7 (Step S311), and a response packet is generated by the CPU 73 (Step S312). The generated response packet is stored in the memory 71.

Next, processing for transmitting the response packet to the client 2 will be described with reference to FIGS. 1, 5A, 6, 7 and 11.

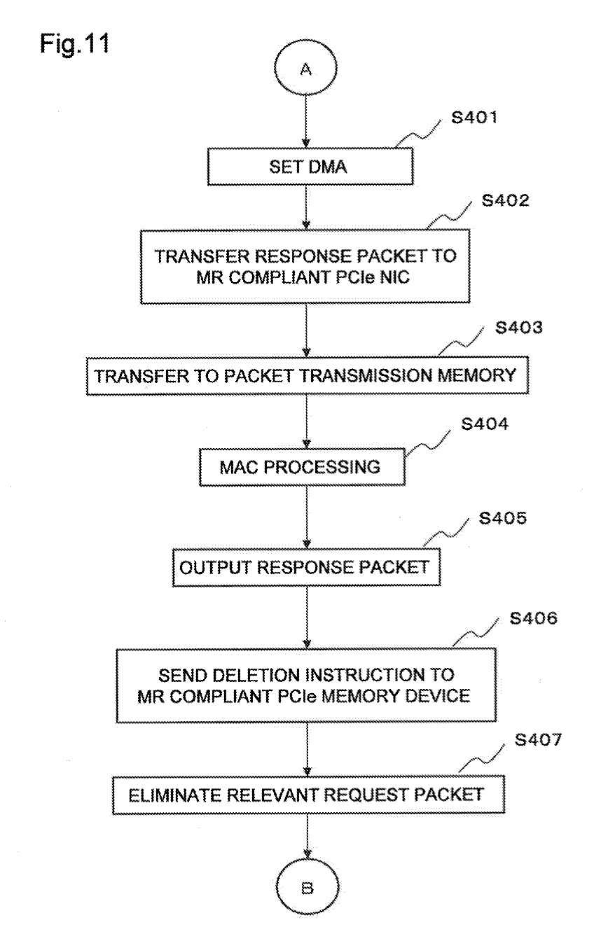

FIG. 11 shows a flow of operations for transmitting the response packet to the client 2.

When the processing unit 7 generates a response packet, the processing unit 7 sets a DMA controller 45 and a DMA control register 46 of the MR compliant PCIe NIC 4, and selects a DMA controller 45 and a DMA control register 46 which transfer the generated response packet (Step S401). The DMA controller 45 and DMA control register 46, which have been set, read the response packet from the memory 73 of the processing unit 7, and transfer it to the MR compliant PCIe NIC 4 (Step S402). That is, the response packet is transferred to the packet transmission memory 42, which the DMA controller 45 set by the processing unit 7 controls, via the chipset 72 of the processing unit 7, the MR compliant PCIe switch 6 and the multi-root PCIe controller 41 of the MR compliant PCIe NIC 4 (Step S403). The transferred response packet undergoes MAC processing in the media access controller (MAC) 44 (Step S404). The response packet, which has undergone the MAC processing, is outputted to the client side network 3 and sent to the client 2 that has issued the request packet (Step S405). After transmitting the response packet, the processing unit 7 sends an instruction to delete the request packet, which the processing unit 7 has processed, to the MR compliant PCIe storage device 5 (Step S406). The memory controller 51 of the MR compliant PCIe storage device 5 that has received the deletion instruction eliminates the request packet stored in the flow identification packet storage memory 521 or the State-less packet storage memory 53 (Step S407).

Setting processing for the MR compliant PCIe NIC 4 and the MR compliant PCIe storage device 5 is performed by setting the MR compliant PCIe configuration registers 47 and 59 and the DMA control registers 46 and 58 by the processing unit 7.

As shown in the flowcharts of FIGS. 10 and 11, a request packet is processed by the processing unit 7, a response packet is generated, and after the response packet has been transmitted, processing of a request packet by the processing unit 7 newly begins.

On the other hand, reception processing of the request packet shown in the flow chart of FIG. 9 is independent from these processings.

The distributed processing system 1 according to the second exemplary embodiment of the present invention includes one MR compliant PCIe NIC 4 and one MR compliant PCIe storage device 5 as mentioned above, but may include plural MR compliant PCIe NIC 4 and plural MR compliant PCIe storage device 5.

The distributed processing system according to the second exemplary embodiment of the present invention includes the MR compliant PCIe device, and stores the arrived packet in a storage device using DMA transfer, and each processing unit processes autonomously the stored packet. As a result, the TCP/IP transfer overhead can be reduced. The bottleneck for the whole processing speed that has been a problem is eliminated. Also, the distributed processing does not include a complicated algorithm. For this reason, the performance of the system improves.

### The Third Exemplary Embodiment

The third exemplary embodiment in which the present invention is suitably implemented will be described.

In a distributed processing system 1 according to the third exemplary embodiment, the same reference signs are given to members and operations overlapping with those of the distributed processing system 1 according to the first and second exemplary embodiments, and thus descriptions of them will be omitted.

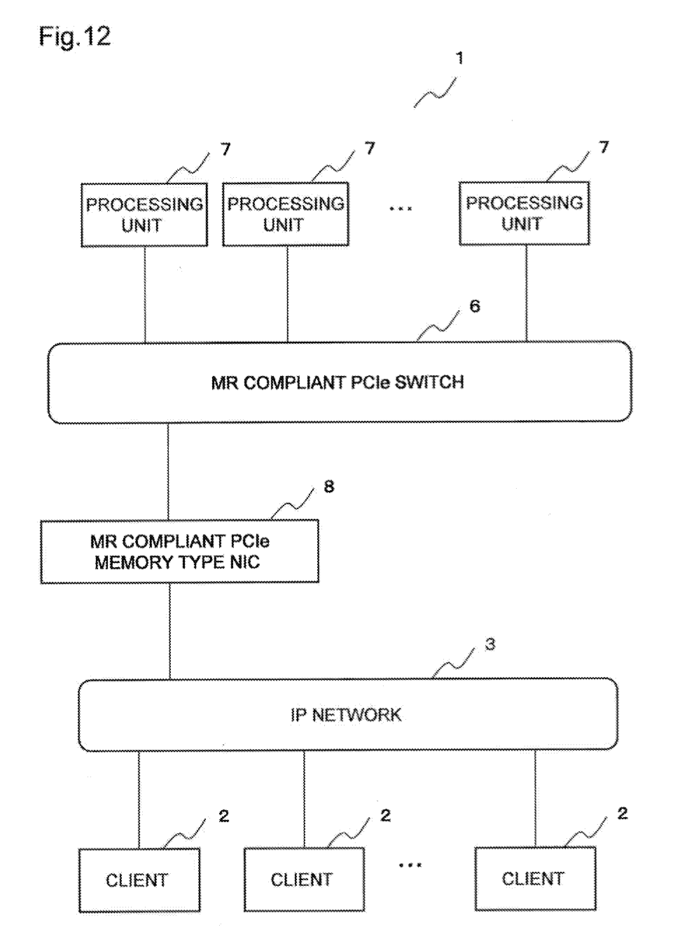

A configuration of a distributed processing system according to the third exemplary embodiment is shown in FIG. 12. The distributed processing system 1 includes: a MR compliant PCIe memory type NIC 8 connected to a client 2 on an IP network 3; and a MR compliant PCIe switch 6 that is connected to MR compliant PCIe memory type NIC 8. Further, a processing unit 7 that processes a request from the client 2 is connected to the MR compliant PCIe switch 6. A processing unit 7 and the MR compliant PCIe switch 6 are the same as in the second exemplary embodiment. The MR compliant PCIe memory type NIC 8 performs receiving a request from the client, recording of the request and transmitting a reply to the client.

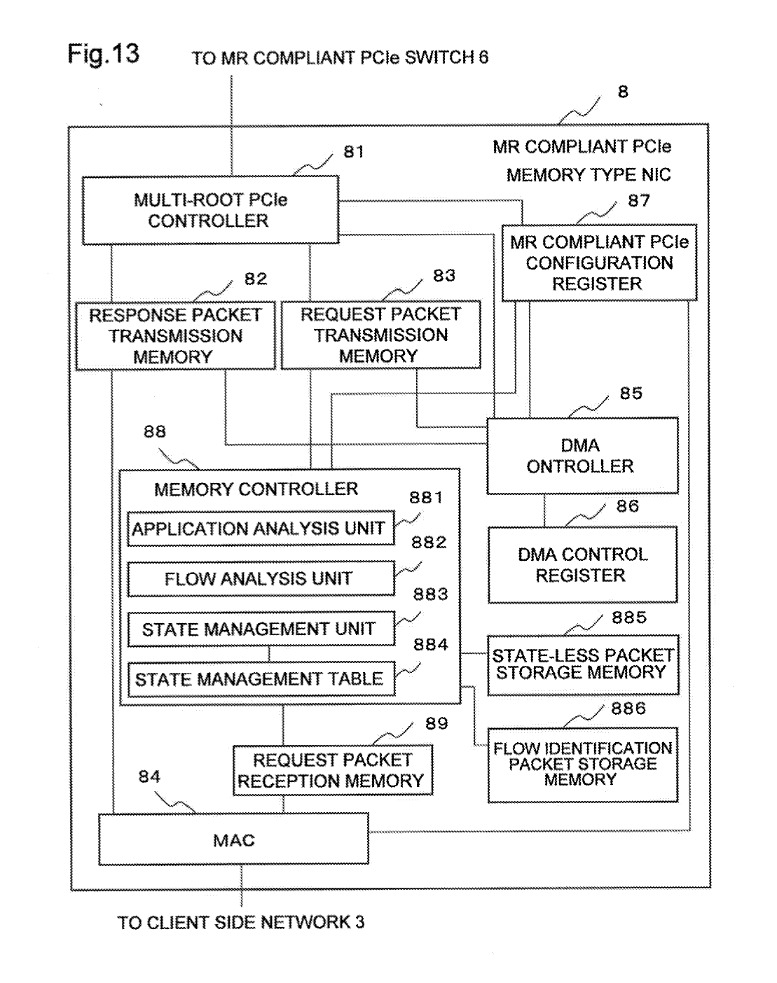

FIG. 13 shows an example of a configuration of the MR compliant PCIe memory type NIC 8 according to the third exemplary embodiment of the present invention. The MR compliant PCIe memory type NIC 8 includes: a multi-root PCIe controller 81 connected to the MR compliant PCIe switch 6; a media access controller (MAC) 84 connected to the client side network 3; and a response packet transmission memory 82 connected to the multi-root PCIe controller 81 and the MAC 84. The MR compliant PCIe memory type NIC 8 further includes: a memory controller 88; a request packet transmission memory 83 connected to the multi-root PCIe controller 81 and the memory controller 88; and a request packet reception memory 89 connected to the MAC 84 and the memory controller 88. The MR compliant PCIe memory type NIC 8 further includes a DMA controller 85 connected to the multi-root PCIe controller 81, the response packet transmission memory 82 and the request packet transmission memory 83. A DMA control register 86 is connected to the DMA controller 85. A MR compliant PCIe configuration register 87 is connected to the multi-root PCIe controller 81, the memory controller 88, the DMA controller 85 and the MAC 84. Meanwhile, the response packet transmission memory 82 may be a plurality of memories. The request packet transmission memory 83 may be a plurality of memories, and the request packet reception memory 89 may be a plurality of memories. Further, the MR compliant DMA controller 85 may also be a plurality of controllers. Also, the DMA control register 86 may be a plurality of registers.

The memory controller 88 includes an application analysis unit 881, a flow analysis unit 882, a State management unit 883 and a State management table 884. To the memory controller 88, a flow identification packet storage memory 886 and a State-less packet storage memory 885 are connected.

The MR compliant PCIe memory type NIC 8 according to the third exemplary embodiment receives a request packet from the client 2, stores the request packet, and transmits a response packet generated by the processing unit 7 that has processed the request packet.

The MR compliant PCIe memory type NIC 8 includes the multi-root PCIe controller 81 and the MR compliant PCIe configuration register 87. More than one processing unit 7 simultaneously uses the MR compliant PCIe memory type NIC 8 via the MR compliant PCIe switch 6, according to the method described in non-patent document 1.

The MR compliant PCIe memory type NIC 8 is preferably an auxiliary storage, and, in particular, is an auxiliary storage, in which a seek time is short, and high-speed read and write is possible. The auxiliary storage is a SSD (Solid State Drive) or the like, for example. Because a data volume of the packet stored in the MR compliant PCIe memory type NIC 8 is small, when a seek time is shortened by adopting the auxiliary storage, the read and write speed of data becomes high, and thus the processing time for the distributed processing system 1 is reduced.

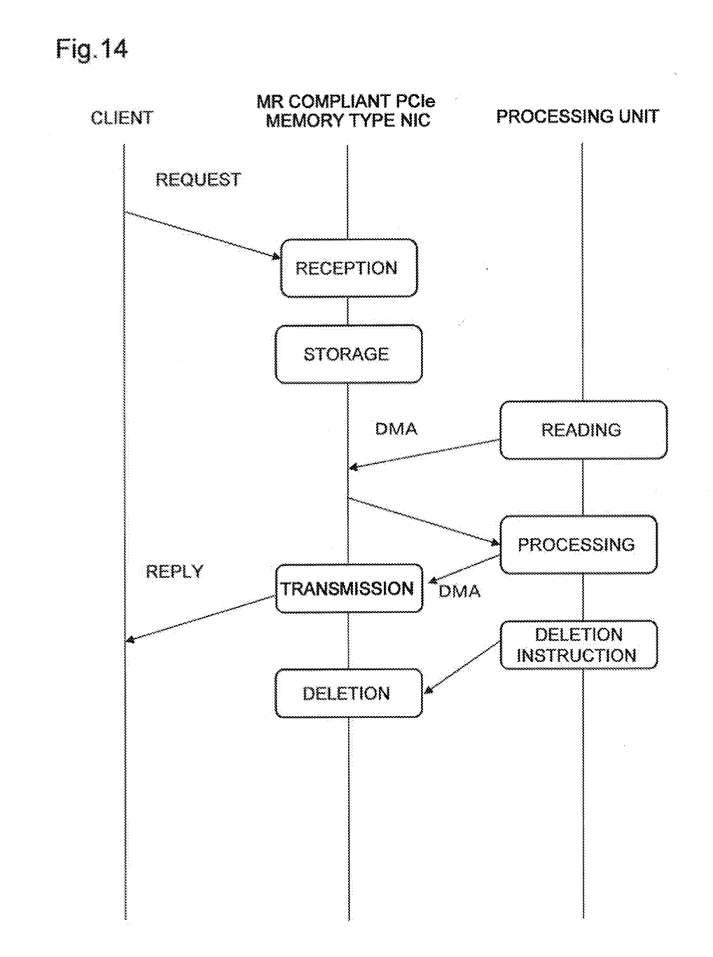

Next, an example of operations of the distributed processing system 1 according to the third exemplary embodiment of the present invention will be described with reference to FIGS. 12 and 14. FIG. 14 schematically shows an example of a sequence of operations of the distributed processing system 1.

A request transmitted from the client 2 passes the IP network 3 as a TCP/IP packet, and is received at the MR compliant PCIe memory type NIC 8. The request packet is stored in the MR compliant PCIe memory type NIC 8. This operation is performed for each receiving the request packet.

On the other hand, the read operation of the processing unit 7 is controlled based on a load status. That is, according to the status of the load on the processing unit 7, a request packet is read from the MR compliant PCIe memory type NIC 8 by DMA transfer, and the request packet is processed by the processing unit 7. When the processing of the request is completed, the processing unit 7 generates a response packet and transfers the generated response packet to the MR compliant PCIe memory type NIC 8 by DMA transfer. The MR compliant PCIe memory type NIC 8 transmits the transferred response packet to the client 2. Further, the processing unit 7 transmits a deletion instruction to the MR compliant PCIe memory type NIC 8. The MR compliant PCIe memory type NIC 8 eliminates the stored request packet according to the deletion instruction. In the operations from the request packet reception to the response packet transfer, data transfer is performed by DMA transfer via the MR compliant PCIe switch 6.

Next, operations of the distributed processing system 1 according to the third exemplary embodiment of the present invention will be described in detail.

First, the operations on receiving the request packet from the client 2 will be described with reference to FIGS. 12, 13 and 15.

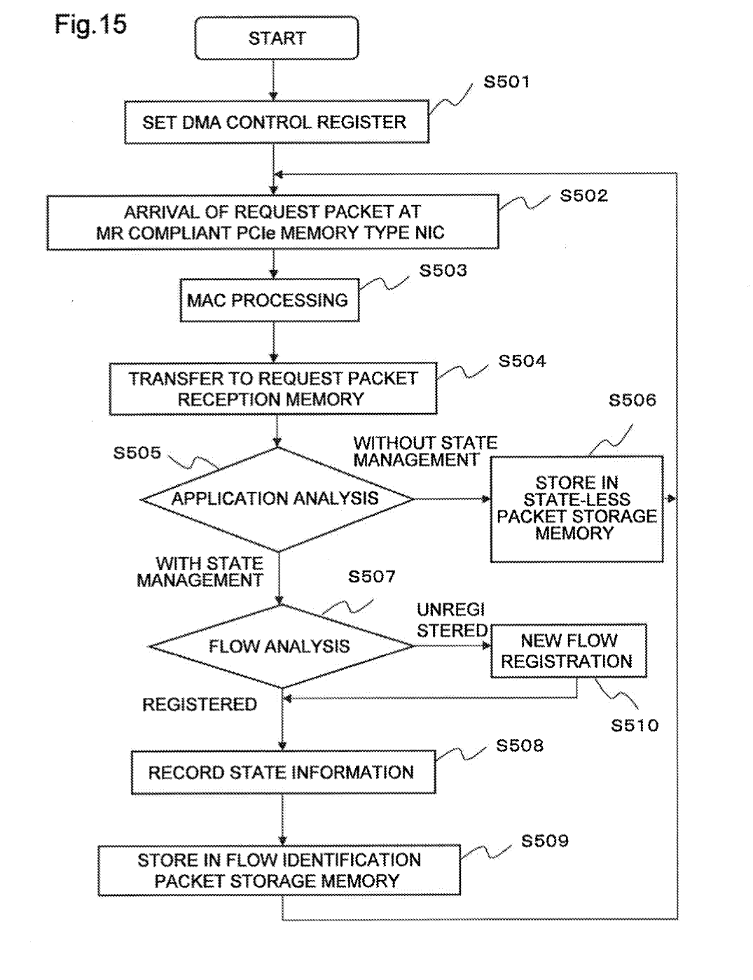

FIG. 15 shows a flow of operations when the request packet has arrived from the client 2.

After a start-up of the system, the DMA control register 86 of the MR compliant PCIe memory type NIC 8 is set (Step S501). When the MR compliant PCIe memory type NIC 8 receives a request packet via the client side network 3 from the client 2 (Step S502), the received request packet undergoes MAC processing in the media access controller 84 (Step S503). The request packet that has undergone the MAC processing is transferred to the request packet reception memory 89 (Step S504).

The memory controller 88 reads out the request packet from the request packet reception memory 89. In the application analysis unit 881, it is determined whether the read request packet requires the State management and needs to be stored for each of the flows (Step S505).

When the processing required by the request packet is determined to be a State-less application (Step S505/Without State management), the request packet is stored in the State-less packet storage memory 885 (Step S506). Meanwhile, preferably the State-less packet storage memory 885 is the FIFO type.

When the processing required by the request packet is determined to be an application, which requires State management (Step S505/With State management), a flow is analyzed in the flow analysis unit 882 (Step S507). In this flow analysis, a flow is classified based on the classification of the client 2 that has transmitted the request packet. State information, of the request packet, for which a flow has been analyzed, is recorded in the State management table 884 shown in FIG. 9 (Step S508).

The request packet, whose State information has been recorded, is stored in the flow identification packet storage memory 886 (Step S509). The flow identification packet storage memory 886 includes a storage area classified by a flow so that a request packet may be stored at each of flows.

When there is a storage area, in which a different request packet having the flow of the request packet analyzed by the flow analysis unit 882 has been already stored (Step S507/Already registered), the analyzed request packet is stored in that storage area so as to be processed after the different request packet that has been already stored.

When a different request packet with the flow of the request packet analyzed by the flow analysis unit 882 has not been stored yet (Step S507/Not registered), a storage area is newly prepared for this flow (Step S510), and the request packet is stored in this storage area.

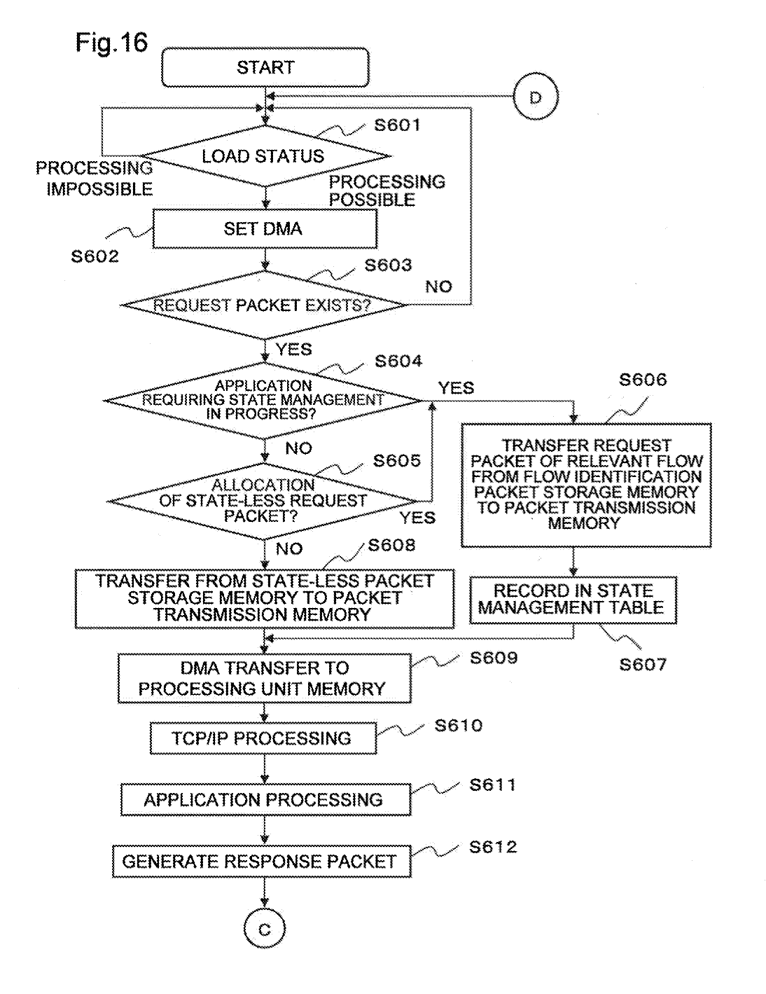

Next, processing of a request packet by the processing unit 7 will be described with reference to FIGS. 12, 5A, 13 and 16. FIG. 16 shows a flow of operations in request packet processing of the processing unit 7.

The processing unit 7 monitors a state of a load on the processing unit 7 as needed. That is, the processing unit 7 determines as needed whether it is a situation that a request packet can be processed (Step S601). When it is a situation that the processing unit 7 can process the request packet (Step S601/Processing possible), information indicating that the processing is possible is transmitted to the MR compliant PCIe memory type NIC 8, and the situation of the processing unit 7 is set to the DMA controller 85 and the DMA control register 86 (Step S602).

It is determined whether a request packet to be processed by the processing unit 7 is stored in the MR compliant PCIe memory type NIC 8 (Step S603), and when the request packet is stored (Step S603/YES), the request packet is transferred by the DMA controller 85 and the DMA control register 86 to the memory 71 of the processing unit 7.

When the MR compliant PCIe memory type NIC 8 transfers a request packet to the processing unit 7, the request packet to be transferred is selected according to the following procedure.

(1) When the processing unit 7 has already started an application which processes the request packet, which requires State management (step S604/YES), a request packet with a flow, to be processed by the application, is read from the flow identification packet storage memory 886. The DMA controller 85 includes a plurality of controllers, and the processing unit 7, capable of processing, selects one controller from the plurality, controllers. The request packet transmission memory 83 includes a plurality of storage areas, and a storage area, which is controlled by the DMA controller 85 selected by the processing unit 7, is selected from the plurality of storage areas. The request packet is transferred from the flow identification packet storage memory 886 to the storage area by the controller (Step S606). Changes in the states of the processing unit 7 and the flow identification packet storage memory 886 due to transfer of the request packet are recorded in the State management table 884 by the State management unit 883 (Step S607), and the request packet is transferred to the memory 71 of the processing unit 7 by DMA transfer (Step S609).

(2) When the processing unit 7 has not yet started application for processing a request packet, which requires State management (step S604/NO), a request packet is read out from any one of the flow identification packet storage memory 886 and State-less packet storage memory 885. When the request packet has been read from the flow identification packet storage memory 886 (step S605/YES), the read request packet is transferred to a storage area of the request packet transmission memory 83 that the DMA controller 85 controls (Step S606). The flow of the read request packet and information regarding the processing unit 7, to which processing has been assigned, is registered by the State management unit 883 in the State management table 884 (Step S607). The request packet transferred to the request packet transmission memory 83 is transferred by the DMA controller 85 to the memory 71 of the processing unit 7 (Step S609). When a request packet has been read from the State-less packet storage memory 885 (Step S605/NO), the request packet is transferred from the State-less packet storage memory 885 to a storage area of the request packet transmission memory 83 that the DMA controller 57 controls (Step S608). The request packet transferred to the request packet transmission memory 83 is transferred by the DMA controller 85 to the memory 71 of the processing unit 7 without performing registration processing to the State management table 884.

The ratio of the number of times that the request packet is read from the flow identification packet storage memory 886 to the number of times that the request packet is read from the State-less packet storage memory 885 is decided according to a reading algorithm, such as a round robin and a weighted round robin, which operates in the memory controller 51.

The request packet is transferred to the memory 71 of the processing unit 7 via the multi-root PCIe controller 81, the MR compliant PCIe switch 6 and the chipset 72 of the processing unit 7 (Step S609). The request packet, which has arrived at the memory 71, undergoes TCP/IP processing by the CPU 73 of the processing unit 7 (Step S610). The request packet, which has undergone TCP/IP processing, is further processed by an application, which is activated in the processing unit 7 (Step S611), and a response packet is generated by the CPU 73 (Step S612). The generated response packet is stored in the memory 71.

Next, processing for transmitting the response packet to the client 2 will be described with reference to FIGS. 12, 5A, 13 and 17.

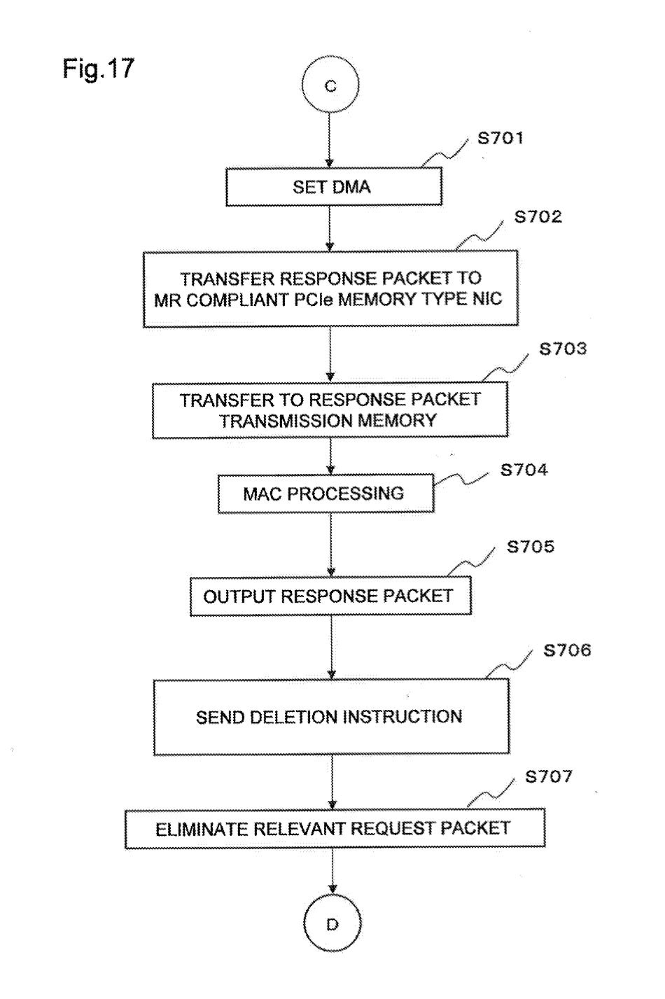

FIG. 17 shows a flow of operations for transmitting the response packet to the client 2.

When the processing unit 7 generates a response packet, the processing unit 7 sets a DMA controller 85 and a DMA control register 86, and selects the DMA controller 85 and the DMA control register 86, which transfer the generated response packet (Step S701). The DMA controller 85 and DMA control register 86, which have been set, read the response packet from the memory 73 of the processing unit 7 and transfer it to the MR compliant PCIe memory type NIC 8 (Step S702). That is, the response packet is transferred to the response packet transmission memory 82, which the DMA controller 85 set by the processing unit 7 controls, via the chipset 72 of the processing unit 7, the MR compliant PCIe switch 6 and the multi-root PCIe controller 81 of the MR compliant PCIe memory type NIC 8 (Step S703). The transferred response packet undergoes MAC processing in the media access controller (MAC) 84 (Step S704). The response packet, which has undergone the MAC processing, is outputted to the client side network 3 and sent to the client 2 that has issued the request packet (Step S705). After transmitting the response packet, the processing unit 7 sends an instruction to delete the request packet, which the processing unit 7 has processed, to the MR compliant PCIe memory type NIC 8 (Step S706). The memory controller 88 that has received the deletion instruction eliminates the request packet stored in the flow identification packet storage memory 886 or the State-less packet storage memory 885 (Step S707).

Setting processing for the MR compliant PCIe memory type NIC 8 is performed by setting the MR compliant PCIe configuration register 87 and the DMA control register 86 by the processing unit 7.

As shown in the flowcharts of FIGS. 16 and 17, the request packet is processed by the processing unit 7, a response packet is generated, and after the response packet has been transmitted, processing of a request packet by the processing unit 7 newly begins. On the other hand, reception processing of the request packet shown in the flow chart of FIG. 15 is independent from these processings.

The distributed processing system 1 according to the third exemplary embodiment of the present invention includes one MR compliant PCIe memory type NIC 8 as mentioned above, but may include plural MR compliant PCIe memory type NIC 8 may be included.

The distributed processing system according to the third exemplary embodiment of the present invention includes the MR compliant PCIe device, and an arrived packet is stored in the storage device using DMA transfer, and each processing unit autonomously processes the stored packet. Receiving the request packet, storing the request packet and transmitting the response packet are processed in the MR compliant PCIe memory type NIC. As a result, the TCP/IP transfer overhead is further reduced compared with the processing in the distributed processing system according to the second exemplary embodiment, in which the request packet is transferred via the MR compliant PCIe switch. The bottleneck of the whole processing speed that has been a problem is eliminated. For this reason, the performance of the system further improves.

### The Fourth Exemplary Embodiment

The fourth exemplary embodiment in which the present invention is suitably implemented will be described.

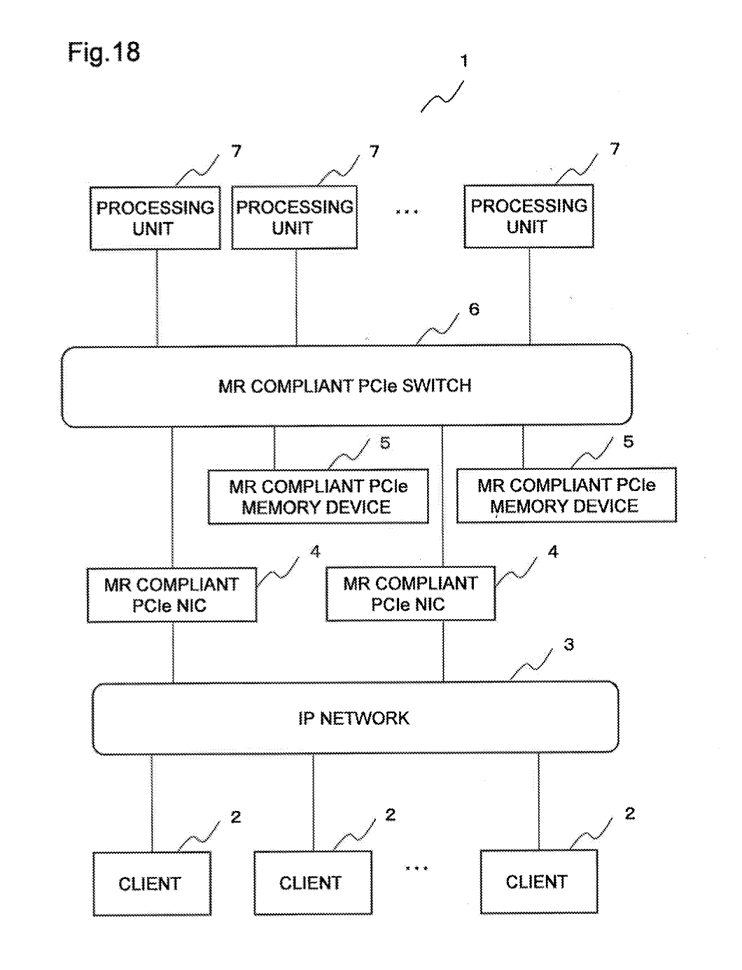

A configuration of a distributed processing system according to the fourth exemplary embodiment is shown in FIG. 18. The distributed processing system 1 includes more than one MR compliant PCIe NIC 4 connected to a client 2 on an IP network 3, and a MR compliant PCIe switch 6 connected to the more than one MR compliant PCIe NIC 4. More than one MR compliant PCIe storage devices 5 are connected to the MR compliant PCIe switch 6. Further, a processing unit 7 that processes a request from the client 2 is connected to the MR compliant PCIe switch 6. Configurations of the processing unit 7, the MR compliant PCIe switch 6, the MR compliant PCIe NIC 4 and the MR compliant PCIe storage device 5 are the same as in the second exemplary embodiment. Meanwhile, in FIG. 18, the distributed processing system includes two MR compliant PCIe NIC 4 and two MR compliant PCIe storage devices 5, but may include no smaller than three MR compliant PCIe NIC 4 and also may include no smaller than three MR compliant PCIe storage devices 5.

Operations for the processing unit 7, the MR compliant PCIe switch 6, the MR compliant PCIe NIC 4 and the MR compliant PCIe storage device 5 in the distributed processing system 1 according to the fourth exemplary embodiment are the same as in the second exemplary embodiment.

In the distributed processing system 1 according to the fourth exemplary embodiment, setting is made in advance so that the MR compliant PCIe NIC 4 and the MR compliant PCIe storage device 5, used for processing a request packet, are designated for each of the client 2 that is a source of the processing request and for each of the processing unit 7 that executes the processing. By this setting, the same operations as in the second exemplary embodiment are possible.

The distributed processing system 1 according to the fourth exemplary embodiment includes more than one MR compliant PCIe NIC 4 and more than one MR compliant PCIe storage devices 5, and can process a plurality of request packets from the client 2 in parallel. As a result, the processing capacity for the distributed processing system further improves.

The present invention has been explained with reference to the exemplary embodiments as above, but the present invention is not limited to the above-mentioned exemplary embodiments. Various changes, which a person skilled in the art can understand, can be performed in the configuration and details of the present invention within the scope of the present invention. For example, in each of the above-mentioned exemplary embodiments, the processing units 7 are independent from each other, but each core of a multi-core processor may be the processing unit 7. Furthermore, the MR compliant PCIe switch 6 may be a multi-stage switch.

A control operation in this exemplary embodiment, mentioned above, can be carried out using hardware, software or a configuration combining them. Meanwhile, when processing is performed using software, a program, in which a processing sequence is recorded, may be installed in a memory in a computer, which is incorporated in a dedicated hardware, to be carried out. Or, the program may be installed in a general-purpose computer, which can carry out various kinds of processing, to be executed.

The program can be recorded in advance in a hard disk and a ROM (Read Only Memory) as a recording medium. Or, a program can be stored (recorded) in the removable recording medium temporarily or permanently. Such a removable recording medium may be provided as so-called packaged software. Meanwhile, the removable recording medium includes a floppy (registered trademark) disk, a CD-ROM (Compact Disc Read Only Memory), a MO (Magneto optical) disk, a DVD (Digital Versatile Disc), a magnetic disk and a semiconductor memory. The program is installed into a computer from the removable recording medium, as mentioned above. Also, it is wirelessly transferred from a download site to a computer. Or, it may be transferred to a computer wiredly via a network.

This application claims priority based on Japanese Patent Application No. 2009-070310, filed on Mar. 23, 2009, the disclosure of which is incorporated herein in its entirety.

### INDUSTRIAL APPLICABILITY

The present invention can be applied to a system for distributing processing requests to a plurality of processing means connected to a network, to process them.

### DESCRIPTION OF REFERENCE SIGNS

1, 1001 Distributed processing system
2, 1012 Client
3, 1003, 1005 IP network
4 MR compliant PCIe NIC
5 MR compliant PCIe storage device
6 MR compliant PCIe switch
7 Processing unit
8 MR compliant PCIe memory type NIC
41, 54, 81 Multi-root PCIe controller
42, 55 Packet transmission memory
43, 56 Packet reception memory
44, 84 MAC
45, 57, 85 DMA controller
46, 58, 86 DMA control register
47, 59, 87 MR compliant PCIe configuration register
51, 88 Memory controller
52 State management packet storage memory
53 and 885 State-less packet storage memory
71, 1042, 1062 Memory
72, 1043, 1063 Chipset
73, 1044, 1064 CPU
82 Response packet transmission memory
83 Request packet transmission memory
89 Request packet reception memory
511, 881 Application analysis unit
512, 882 Flow analysis unit
513, 883 State management unit
514, 884 State management table
521, 886 Flow identification packet storage memory
1002 Client group
1004 Load balancer
1006 Server group
1016 Server
Client side NIC
1045 Server side NIC
1061 NIC

1. A distributed processing system, comprising:
a processing unit that processes a request from a request unit, connected to a network, and generates a reply, and includes a second control unit that detects a load;
a switch connected to said processing unit;
a memory unit connected to said switch, said memory unit including:
a first control unit that determines whether state management is required for said request transferred from said request unit;
a first storage unit that stores the request when the request requires the state management; and
a second storage unit that stores the request when the request does not require the state management,
said request stored in said first storage unit or said second storage unit being eliminated by said first control unit based on an instruction from said processing unit, and
said request stored in said first storage unit or said second storage unit being read out by said second control unit according to said load; and
an interface, connected to the network, and said switch, said interface transferring the request from said request unit to said memory unit and transferring said reply to said request unit, and said generated reply being outputted to said interface by said second control unit.

2. The distributed processing system according to claim 1, wherein said processing unit reads out said request using Direct Memory Access (DMA) transfer, and outputs said reply to said interface using the DMA transfer.

3. The distributed processing system according to claim 1, wherein
said memory unit comprises an analyzing unit that analyzes a flow of the request which requires said state management, and
said second storage unit classifies and stores said request based on said flow or an instruction from said processing unit.

4. The distributed processing system according to claim 1, wherein said memory unit is an auxiliary storage.

5. The distributed processing system according to claim 1, wherein said interface transfers said request to said memory unit using the DMA transfer.

6. The distributed processing system according to claim 1, wherein said interface includes said memory unit.

7. The distributed processing system according to claim 1, wherein said second storage unit is a storage device of a FIFO (First In and First Out) type.

8. An interface connected to a network and a switch, a processing unit, which processes a request from a request unit and generates a reply, and a memory unit being connected to said switch, and said request unit being connected to said network, said interface comprising:
a transfer unit that transfers a request from said request unit to said memory unit, and transfers said reply to said request unit, said request being transferred to said memory unit using DMA transfer.

9. A memory unit connected to a switch, to which a processing unit that processes a request from a request unit and generates a reply, and an interface, connected to a network, said request unit being connected to said network, said interface transferring said reply to said request unit are connected, said memory unit comprising:
a first control unit that determines whether state management is required for a request from said request unit transferred from said interface or not;
a first storage unit that stores the request, when the request requires the state management; and
a second storage unit that stores the request, when the request does not require the state management,
said request stored in said first storage unit or said second storage unit being eliminated by said first control unit based on an instruction from said processing unit.

10. The memory means according to claim 9, further comprising:
an analyzing unit that analyzes a flow of the request which requires said state management, wherein
said second storage unit classifies and stores said request based on said flow or an instruction from said processing unit.

11. A distributed processing method in a system, which includes: a processing unit that processes a request from a request unit connected to a network and generates a reply; a switch connected to said processing unit; a memory unit connected to said switch; and an interface connected to said network and to said switch, said method comprising:
transferring a request from said request unit to said memory unit;
determining whether state management is required for said transferred request or not;
storing said request in a first storage unit when said request requires the state management;
storing said request in a second storage unit when said request does not require the state management;
reading out said request according to a load on said processing means, and transferring said request to said processing unit;
transferring a reply generated by processing said request to said request unit; and
eliminating said request stored in said first storage unit or said second storage unit.

12. A distributed processing program in a system, which includes: a processing unit that processes a request from a request unit connected to a network and generates a reply; a switch connected to said processing unit; a memory unit connected to said switch; and an interface connected to said network and to said switch, said program causing a computer to execute:
a transfer process for transferring a request from said request unit to said memory unit;
a determining process for determining whether state management is required for said transferred request or not;
a first storing process for storing said request in a first storage means unit when said request requires the state management;
a second storing process for storing said request in a second storage unit when said request does not require the state management;
a readout process for reading out said request according to a load on said processing means, and transferring said request to said processing unit;
a reply process for transferring a reply generated by processing said request to said request unit; and
a eliminate process for eliminating said request stored in said first storage unit or said second storage unit.

13. A recording medium, in which a program which makes a computer execute distributed processing in a system, which includes: a processing unit that processes a request from a request unit connected to a network and generates a reply; a switch connected to said processing unit; a memory unit connected to said switch; and an interface connected to said network and to said switch, said processing comprising:
a transfer process for transferring a request from said request unit to said memory unit;
a determining process for determining whether state management is required for said transferred request or not;
a first storing process for storing said request in a first storage unit when said request requires the state management;
a second storing process for storing said request in a second storage unit when said request does not require the state management;
a readout process for reading out said request according to a load on said processing means, and transferring said request to said processing unit;
a reply process for transferring a reply generated by processing said request to said request unit; and
a eliminate process for eliminating said request stored in said first storage unit or said second storage unit.
